(19) United States
(12) Patent Application Publication
(10) Pub. No.: US 2023/0114482 A1
(43) Pub. Date: Apr. 13, 2023

(54) RainCatch: a car door umbrella

(71) Applicant: Alexandra Kathryn Henry, Newnan, GA (US)

(72) Inventor: Alexandra Kathryn Henry, Newnan, GA (US)

(73) Assignee: Alexandra Kathryn Henry, Newnan, GA (US)

(21) Appl. No.: 17/497,973

(22) Filed: Oct. 10, 2021

(51) Int. Cl. B60J 5/04

(52) U.S. Cl. CPC B60J 5/0494; B60J 5/0468

(57) ABSTRACT

The RainCatch is primarily designed to protect vehicle passengers when opening a car door during rainy weather. In the time it takes to open or close an umbrella then close the door, rain gets onto the door handle, and the passenger gets wet. The RainCatch solves the timing dilemma of the transition between outside to inside the vehicle during bad weather. The RainCatch acts as a protective covering. The design features two pieces of stabilizer covered on both sides with waterproof nylon. It is 135 cm wide when flat to accommodate most door opening widths. The removable RainCatch has six velcro attachments that hang from the headliner and door frame of a car for seamless entry and exit. The accordion design and a drawstring allow it to close and fold with the door's motion. It can be used on both sides of a car and on front and rear doors.

### BACKGROUND

### 1. Field of the Invention

The invention is a removable rain cover for vehicle users/passengers opening car doors during rain. It protects the users and the interior of the vehicle from getting wet. It hangs inside the car between the door frame and car door.

### DESCRIPTION OF THE PRIOR ART

There are many patents similar to the RainCatch with multiple designs all functioning to solve the same problem. However, the designs of these patents differ from the RainCatch in four main ways: they have motors (U.S. Pat. No. 9,827,917); they “roll up” (U.S. Pat. Nos. 5,476,302, 8,276,607); they use elastics or springs (U.S. Pat. No. 5,529,368); or they are mounted on the outside of the car (U.S. Pat. Nos. 5,529,368, 8,240,323). The RainCatch does not have any of the aforementioned qualities. The RainCatch, instead: is hand manipulated; folds; contains flexible stabilizers inside of waterproof nylon; and is mounted inside of the car. These qualities allow the RainCatch to be an innovative solution to a problem many drivers encounter.

### SUMMARY

The RainCatch is a waterproof covering that hangs in the doorframe of a motor vehicle to cover the user while they enter and exit the vehicle during the rain, snow, sleet, or hail (henceforth called “the elements”). It also prevents the elements from falling onto the interior door handle controls. The sturdy yet flexible accordion design allows the RainCatch to fit door widths up to 125 centimeters (50 inches). Threaded parachute cord allows for easy closure of the RainCatch into its condensed accordion form. Six pieces of looped velcro around the perimeter of the RainCatch attach to six pieces of mounted hooked velcro on the vehicle interior. The RainCatch is able to mount to front and rear hinged doors on both sides of a vehicle. Before the first use, the user will mount the hooked velcro pieces to their vehicle interior. The industrial strength adhesive backing is strong enough to hold the weight of the RainCatch without sagging or premature peeling.

The RainCatch's design also allows it to be used outside of a vehicle. The lightweight material makes it an excellent personal covering when outdoors. It can substitute for an umbrella or raincoat if those items are left elsewhere. It provides quick protection from the sun and wind. The shape and size adequately cover the user. The compact accordion design means the RainCatch easily fits into bags or backpacks.

### SPECIFICATIONS

### Materials

Waterproof nylon
70 Ultra Firm Stabilizer
Parachute cord
Cord stops
Eyelets (8 millimeter diameter)
Industrial strength Velcro
Thread
Pony beads

### Dimensions

Total top width: 135 centimeters
Total bottom width: 48 centimeters
Total length: 78 centimeters
Total area coverage: approximately 0.71 meters²
Thickness: approximately 1 centimeter

### Nylon Dimensions

Total top width 48 centimeters
Total middle width: 135 centimeters
Total bottom width: 48 centimeters
Total length 156 centimeters

### Stabilizer Dimensions

### Top Stabilizer

Total top width: 135 centimeters
Total bottom width: 92 centimeters
Total length: 37 centimeters

### Top Stabilizer Pentagon “Cut Out” Dimensions

Total width: 11.5 centimeters
Total length: 5 centimeters
Distance between cutouts: 15.5 centimeters

### Bottom Stabilizer

Total top width: 90 centimeters
Total bottom width: 48 centimeters
Total length: 37 centimeters

### Accordion Design Specifications

“Pleat” width: 13.5 centimeters
Total number of pleats: 10
Number of pleats with eyelets: 6
Looped parachute cord length: approximately 88 centimeters
Number of cord stops: 2
Number of eyelets: 6
Eyelet diameter: 8 millimeters
Eyelet spacing: 13.5 centimeters

### Velcro Specifications

Velcro size: 2.5 centimeters×5 centimeters
Distance from side edge: 2.5 centimeters
Velcro spacing from top to bottom
   Top edge to first piece: 7 centimeters
   First to second piece: 18 centimeters
   Second to third piece: 28 centimeters
   Third piece to bottom edge: 17.5 centimeters

### DESCRIPTION

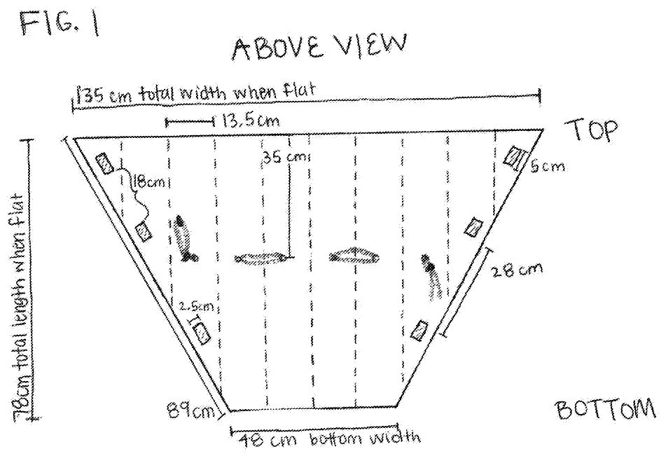

FIG. 1: Bird's eye view of the RainCatch.
This figure shows the above view of the RainCatch specifications when laid totally flat. Vertical dash marks represent each pleat. The folding pattern of the pleats creates the accordion design. Parachute cord with cord stops run through eyelets in the middle six pleats of the RainCatch to close the accordion, and the ends of the parachute cord come through the top. Six looped velcro pieces line the side edges of the RainCatch.

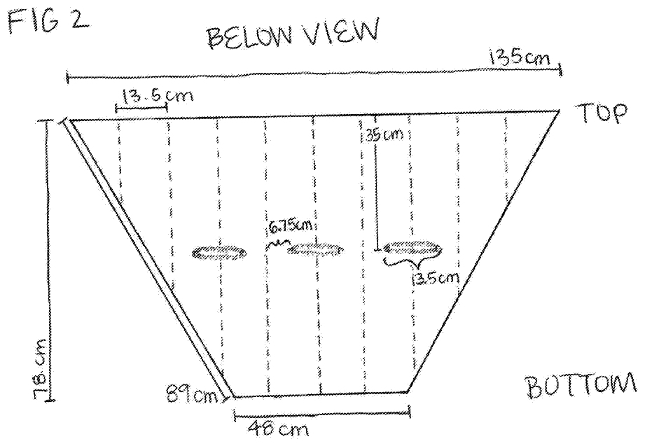

FIG. 2: Ground level view of the RainCatch
This figure shows the below view of the RainCatch specifications when laid totally flat. Dash marks represent each pleat. The folding pattern of the pleats creates the accordion design. Parachute cord runs through eyelets in the middle six pleats of the RainCatch to close the accordion.

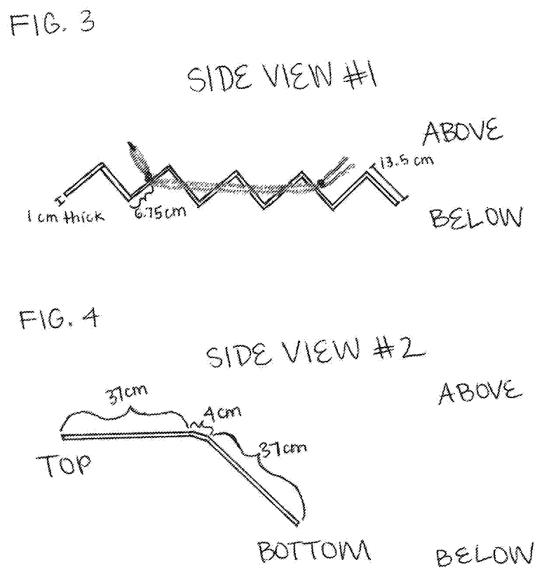

FIG. 3: Side view #1 of the RainCatch
This figure shows a side view of the RainCatch when laid partially folded. The accordion design is shown and features 10 pleats. This figure also illustrates how the parachute cord runs through the middle six pleats with cord stops at the ends.

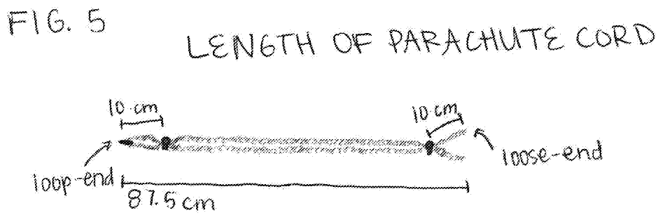

FIG. 4: Side view #2 of the RainCatch
This figure shows a side view of the RainCatch as if it were hanging in the door frame of a vehicle. The two stabilizer pieces are straight with a foldable gap between them.

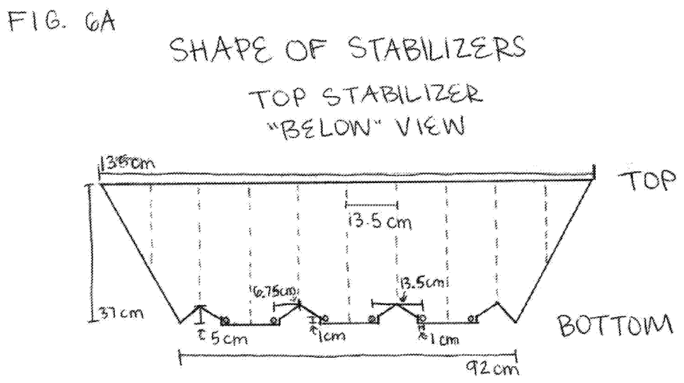

FIG. 5: Length of Parachute Cord
This figure shows the length of parachute cord with cord stops on each end. The parachute cord is doubled to create a two strand pulling mechanism with a loop-end and a loose-end. The cord stops hold the RainCatch in its folded form.

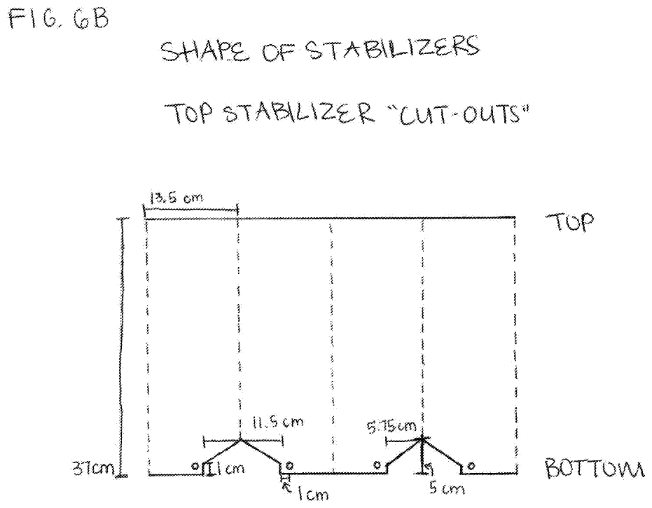

FIG. 6A: Shape of Top Stabilizer
This figure shows the top stabilizer from the below view. Dash marks show where the pleats fold into their accordion design. Cut-outs in the bottom edge of the stabilizer allow the RainCatch to both fold and fit in a variety of window shapes. Eyelet holes are next to the cut-outs.

FIG. 6B: Top Stabilizer Cut-Outs
This figure shows a larger view of the cut-outs and eyelet holes in the middle of the top stabilizer. The cut-outs are at the bottom edge of the second, fourth, sixth, and eighth pleats.

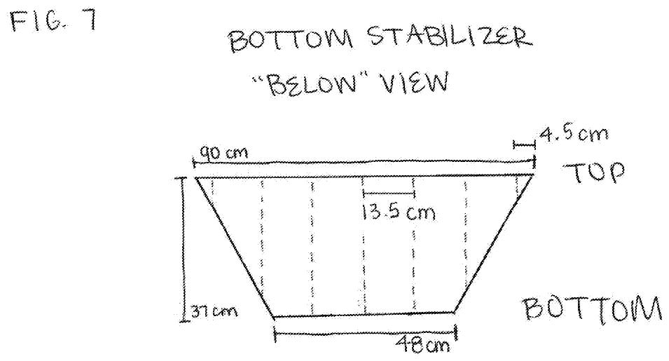

FIG. 7: Shape of Bottom Stabilizer
This figure shows the bottom stabilizer from the below view. Dash marks show where the pleats fold into their accordion design.

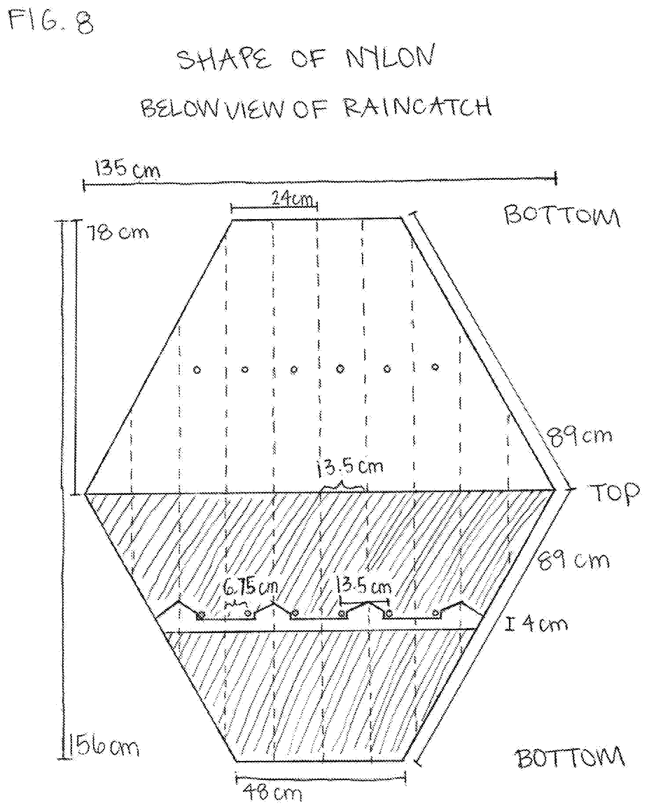

FIG. 8: Shape of Nylon
This figure shows the bottom view of the RainCatch laid totally flat. The RainCatch is nylon on both sides, and in this figure, the nylon is “open” into its total area. Inside of the nylon are top and bottom stabilizers. Eyelet holes are in the nylon and top stabilizer Dash marks show the pleats in the nylon and stabilizer.

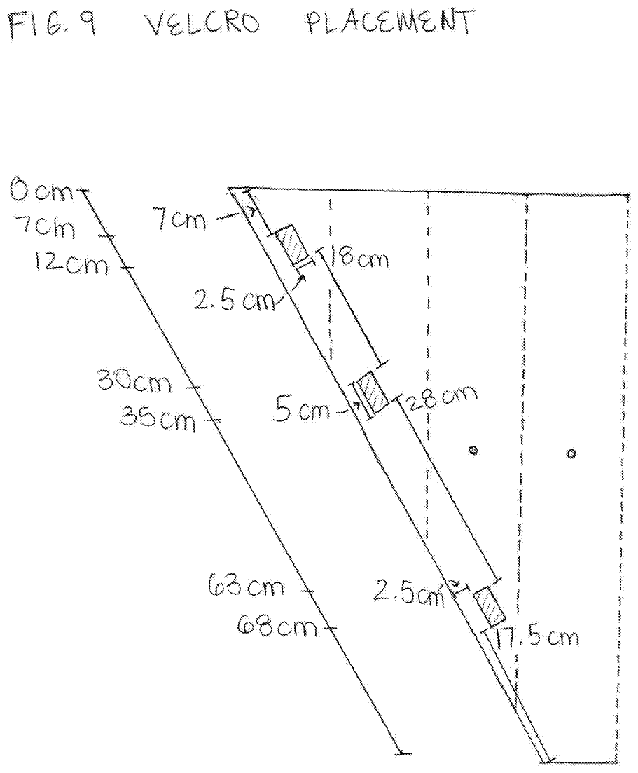

FIG. 9: Velcro Placement
This figure shows the velcro placements on the RainCatch. Three of the six pieces of velcro are shown in this view, and the other three pieces of velcro are in a placement that is the mirror image of this figure. Two of the pieces of velcro are on the top piece of stabilizer, and one piece of velcro is on the bottom piece of stabilizer. These measurements are made parallel to the left and right edges of the RainCatch.

### DETAILED DESCRIPTION

### Method of Making the RainCatch

1) Cut the “top” piece of 70 Ultra Firm Stabilizer into the shape shown in FIG. 6A. Begin by cutting a regular trapezoid: base one 135 centimeters (henceforth, cm), base two 92 cm, and height 37 cm.
2) Cut the “bottom” piece of 70 Ultra Firm Stabilizer into the shape shown in FIG. 7. Begin by cutting a symmetrical trapezoid: base one 90 cm, base two 48 cm, and height 37 cm.
3) Label the big piece of stabilizer “top” and the small piece of stabilizer “bottom.”
4) Mark the midpoints of the parallel bases on the two trapezoids, Top stabilizer base one midpoint: 67.5 cm. Top stabilizer base two midpoint: 46 cm. Bottom stabilizer base one midpoint: 45 cm. Bottom stabilizer base two midpoint: 24 cm.
5) Draw a straight line between the midpoints of each base on both pieces of stabilizer
6) Label one side of both pieces of stabilizer “outside,”
7) Label the other side of both pieces of stabilizer “inside.”
8) Lie both pieces of stabilizer with “inside” facing up.
9) Fold both pieces of stabilizer so that the “outside” face of the stabilizer is on the outside. You should see the “outside” label written when the stabilizers are folded.
10) Iron the creases along the midline on both pieces of stabilizer. Be sure to keep the edges aligned. Slowly move the iron across the stabilizer to set the crease.
11) Open both pieces of stabilizer with “inside” facing up.
12) Measure off ten pleats 13.5 cm wide starting from the corner along base one on the top piece of stabilizer. FIG. 6A and FIG. 6B show vertical dash marks representing pleats. Use FIG. 6A to be sure you have the correct number of pleat marks (10).
13) Measure off seven pleats 13.5 cm wide starting 4.5 cm from the corner along base one on the bottom piece of stabilizer FIG. 7 shows vertical dash marks representing pleats. Use FIG. 7 to be sure you have the correct number of pleat marks (seven).
14) Open the top piece of stabilizer with “inside” facing up. Orient the stabilizer as shown in FIG. 6A, Fold the top piece of stabilizer along its crease. Take the right half of the trapezoid and fold it backwards (“inside” facing out) at the 13.5 cm pleat mark. Use the straight edge as a guide to fold the pleat.
15) Slowly move the iron across the stabilizer to set the new crease. The stabilizer should have two creases in a zigzag shape. FIG. 3. shows the folding pattern.
16) Continue folding and creasing the right half of the top piece of stabilizer every 13.5 cm using the straight edge as a guide. You should create three new creases.
17) Repeat steps 14-16 with the left half of the top stabilizer You should have nine creases and ten pleats.
18) Open the bottom piece of stabilizer with “inside” facing up. Orient the stabilizer as shown in FIG. 7. Fold the bottom piece of stabilizer along its crease. Take the right half of the trapezoid and fold it backwards (“inside” facing out) at the 13.5 cm pleat mark. Use the straight edge as a guide to fold the pleat. 19) Slowly move the iron across the stabilizer to set the new crease. The stabilizer should have two creases in a zigzag shape. FIG. 3, shows the folding pattern,
20) Continue folding and creasing the right half of the bottom piece of stabilizer every 13.5 cm using the straight edge as a guide. You should create two new creases.
21) Repeat steps 18-20 with the left half of the bottom stabilizer. You should have seven creases and eight pleats.
22) Orient the top piece of stabilizer as shown in FIG. 6A with the “inside” facing up. Mark the midpoints of the middle six pleats at 6.75 cm,
23) Measure 1 cm perpendicular to base two at the midpoints of the middle six pleats. Use FIG. 6A and FIG. 6B for reference. This 1 cm mark away from the midpoint is the center of the eyelets. Punch eyelet holes into the middle six pleats. The eyelet holes should be 13.5 cm apart
24) Orient the top piece of stabilizer as shown in FIG. 6A with the “inside” facing up. Notice the cut-outs in base two on the second, fourth, sixth, and eighth creases. Using FIG. 6A and FIG. 6B for reference, measure 5 cm from base two up each of the aforementioned creases.
25) Measure 5.75 cm to the left of the fourth, sixth, and eighth creases. Use FIG. 6B for reference.
26) Measure 5.75 cm to the right of the second, fourth, and sixth creases. Use FIG. 6B for reference. The cut-outs should be 11.5 wide and 5 cm tall.
27) Measure 1 cm perpendicular to base two at the 5.75 cm marks on the middle six pleats,
28) Connect the new marks to create the shapes of the cut-outs. Use 1FIG. 6A and FIG. 6B for reference. Starting on the fourth crease, draw a line from the 5 cm mark to the 1 cm mark on the right of the eyelet hole. Connect to the 5.75 cm mark on base two. Draw a line from the 5 cm mark to the 1 cm mark on the left of the eyelet hole. Connect to the 5.75 cm mark on base two.
29) Repeat step 28 on the sixth crease,
30) Draw a line from the bottom left corner of the top piece of stabilizer to the 5 cm mark on the second pleat. Draw a line from the 5 cm mark to the 1 cm mark on the left of the eyelet hole. Connect to the 5.75 cm mark on base two.
31) Draw a line, from the bottom right corner of the top piece of stabilizer to the 5 cm mark on the eighth pleat. Draw a line from the 5 cm mark to the 1 cm mark on the right of the eyelet hole. Connect to the 5.75 cm mark on base two.
32) Cut along the new lines to create the cut-outs. There should be four cut-outs total on the second, fourth, sixth, and eighth creases. Use FIG. 6A and FIG. 6B for reference. The edges of the cut-outs should be 1 cm away from the middle of the nearest eyelet hole.
33) Draw a hexagon on the nylon using the dimensions shown in FIG. 8. Measure 48 cm on the nylon. Mark the midpoint at 24 cm.
34) Measure 156 cm perpendicular to the 48 cm line at the 24 cm mark, Mark the midpoint of this line at 78 cm.
35) Measure 48 cm perpendicular to the 156 cm line with 24 cm on each side of the 156 cm line.
36) Draw a 135 cm line perpendicular to the 156 line through the midpoint at 78 cm.
37) Connect the ends of the 135 cm line to the ends of both 48 cm lines to create the hexagon shape.
38) Cut the nylon into a hexagon as shown in FIG. 8. Leave extra space around the edges to allow for sewing.
39) Orient the nylon with the drawing side up. Orient both pieces of stabilizer with the “inside” facing up and as shown in FIG. 7. Spray the bottom piece of stabilizer with spray-on fabric adhesive. Place it at the bottom edge of the hexagon. Use FIG. 8 for reference.
40) Place the top piece of stabilizer in the middle of the hexagon 4 cm away from the bottom piece of stabilizer. Use FIG. 8 for reference.
41) Sew the bottom half three edges of nylon to the stabilizer pieces.
42) Fold the top half of nylon to cover the “inside” face of the two pieces of stabilizer. Fold the edges to create a neat seam. Sew the top three edges of nylon to the stabilizer pieces.
43) Sew the nylon to the stabilizers down each crease in the stabilizers.
44) Punch six holes into both sides of the nylon through the holes made in the top piece of stabilizer Use FIG. 6A and FIG. 8 for reference.
45) Hammer 8 mm diameter eyelets through the holes to connect the stabilizer to the nylon,
46) Orient the RainCatch as shown in FIG. 1 with the “outside” facing up. The folded seam should be facing down. Lay a meter stick parallel to the left edge of the RainCatch with the ticks 2.5 cm away from the edge of the RainCatch. The “0” tick mark should be at the top edge of the RainCatch. Use FIG. 9 for reference.
47) Peel the backing off of one piece of 2.5 cm×5 cm looped velcro. Place the velcro between 7 cm and 12 cm along the edge of the meter stick. Use FIG. 9 for reference.
48) Peel and place one piece of velcro between 30 cm and 35 cm along the edge of the meter stick. It should be 18 cm away from the previously placed velcro. Use FIG. 9 for reference.
49) Peel and place one piece of velcro between 63 cm and 68 cm along the edge of the meter stick. It should be 28 cm away from the previously placed velcro. It should be 17.5 cm away from the bottom edge. Use FIG. 9 for reference.
50) Repeat steps 46-49 for the right edge of the RainCatch.
51) Sew around the edges of the six pieces of velcro.
52) Measure 175 cm of parachute cord. Put one bead on the length of cord.
53) Fold (loop) the parachute cord in half. Thread the loose-end of the parachute cord through one cord stop. Pull the cord until approximately 10 cm from the loop-end. Use FIG. 5 for reference. The head should be on the loop-end secured by the cord stop.
54) Orient the RainCatch with the “outside” facing up. The folded seam should be facing down. Thread the loose-end of the parachute cord through the eyelets, Use an “over/under” technique for threading. Use FIG. 1 and FIG. 3 for reference,
55) Thread the loose-end of the parachute cord through a second cord stop approximately 10 cm from the loose-end, Use FIG. 5 for reference. Make an ashley stopper knot on both cord ends.

### Method of Using the RainCatch

1) Sit in the car with the door closed.
2) Orient The RainCatch as follows: Unfold the middle of The RainCatch to its full length. Find the short edge parallel to the drawstring. Keep the accordion and drawstring pull closed. Orient The RainCatch with the velcro pieces facing up and the short edge closest to the door hinge.
3) Notice the six velcro attachments on the top of The RainCatch. Hold The RainCatch up to the door frame. Find the ideal positioning where The RainCatch bend in the middle fits flush against the curve in the doorframe.
4) Mark where each piece of velcro aligns on the door frame and headliner. Three attach to the door frame, and three attach to the headliner.
5) Peel the backing off of the hooked side of velcro one at a time. At each of the six previously made markings, firmly press the velcro against the door frame and the headliner for one minute. Do this for all six pieces of velcro.
6) Allow the velcro to mount and set for 24 hours.
7) Hold The RainCatch up to the door frame and headliner. Press the velcro pieces together.
8) Pull the cord stop on the long end of the drawstring to about 10 cm from the end.
9) Open the door. Pull the drawstring taut and adjust the cord stop near the headliner.
10) The RainCatch is ready to use!

1. The Raincatch prevents the user from getting wet from the elements while they open or close the vehicle door when entering or exiting their vehicle.

2. The RainCatch prevents the car interior from getting wet from the elements while the car door is open.

3. The RainCatch can be used as a personal covering to protect the user from the elements, sun, and wind in place of an umbrella or raincoat.
